(19) United States
(12) Patent Application Publication
(10) Pub. No.: US 2018/0240380 A1
(43) Pub. Date: Aug. 23, 2018

(54) POLE-MOUNTABLE DISPLAY SYSTEMS AND METHODS OF USING

(71) Applicant: Michael Joseph Horgash, Valparaiso, IN (US)

(72) Inventor: Michael Joseph Horgash, Valparaiso, IN (US)

(21) Appl. No.: 15/900,955

(22) Filed: Feb. 21, 2018

Related U.S. Application Data
(60) Provisional application No. 62/461,333, filed on Feb. 21, 2017.

(51) Int. Cl. G09F 15/00; G09F 7/18; G09F 7/02; G09F 17/00

(52) U.S. Cl. CPC G09F 15/0037; G09F 7/18; G09F 2007/1804; G09F 17/00; G09F 7/02

(57) ABSTRACT

Pole-mountable display systems and methods for mounting such systems to various types of poles, and particularly to display systems that are capable of bearing advertising, information, and/or decorations (ornamentations) to structures to which they are mounted. Such a pole-mountable display system includes a flexible panel configured to install on a pole by being wrapped around an exterior surface of the pole to define a display surface. The panel has an interior surface, an exterior surface that defines the display surface, oppositely-disposed first and second edges, and connector means for securing the first and second edges together. The system further includes a support means for providing rigidity to the flexible panel, and a sleeve adapted to conform to and contact the exterior surface of the pole causing the display surface of the panel to have a greater width or diameter than the pole around which the panel is wrapped.

### CROSS REFERENCE TO RELATED APPLICATIONS

This application claims the benefit of U.S. Provisional Application No. 62/461,333, filed Feb. 21, 2017, the contents of which are incorporated herein by reference.

### BACKGROUND OF THE INVENTION

The present invention generally relates to media used for advertising or displaying information. The invention particularly relates to pole-mountable display systems capable of being mounted to various types of poles and other generally upright columnar-shaped structure, wherein the display systems are capable of bearing advertising, information, and/or decorations (ornamentations) and are preferably capable of being quickly and easily removed from a pole.

Owners and operators of properties have long recognized the value of placing advertising, information, and decorative designs on upright vertical poles (as nonlimiting examples, light poles and other columnar-shaped structures) located on their properties. Representative is a pole cover taught by U.S. Pat. No. 5,212,898 to Dinan et al. The Dinan et al. device is a two-piece device that utilizes mostly thin flexible planar panels affixed to each other in a manner which captures or sandwiches a pole between the panels. This device allows displaying an advertising message or decorative design on a pole or other columnar structure. While appearing to be an acceptable manner to display a message, the Dinan et al. device has drawbacks. For example, in order to not interfere with passing vehicle or pedestrian traffic, these devices are typically placed in a manner which is substantially above the ground surface. This can cause a person passing by the device to not see or observe the intended message or decoration being displayed.

Another drawback of the Dinan et al. device is that cumbersome equipment must be employed to mount or install the device, such as a lifting mechanism which can carry personnel upward into the air to the desired mounting location. Of course, this same cumbersome equipment must also be employed to demount or remove the device. Because this process can be relatively time consuming and expensive, the message carried by this device tends to become stale or faded from being displayed for an extended period of time. Yet another perceived deficiency is that the device is mounted in a manner that results in the device inherently exhibiting a certain amount of drag or resistance against wind. A pole cover device taught by U.S. Pat. No. 4,890,403 to Dinan also appears to share shortcomings of the Dinan et al. device.

In an attempt to bring greater visual awareness to advertising on vertical poles, U.S. Pat. Nos. 6,061,939 and 5,782,027 to Gildea teach a decorative member attached to the bottom or lower portion of a vertical pole. Although these devices are physically easier to reach, thus easier to install and remove in comparison to the Dinan and Dinan et al. devices, the view of the Gildea devices can be easily obscured if vehicles are parked in close proximity to the pole where the device is mounted. Since the devices taught by Gildea are of a semi-rigid three-dimensional construction, they tend to project outward in relation to the lower portion of the pole or its station. These outwardly projecting portions are unsupported by the pole or its station and can cause the Gildea devices to become damaged from contact with vehicles or intentional damage from pedestrians. The devices taught by Gildea also appear to be somewhat expensive to manufacture.

U.S. Pat. No. 6,363,644 to Frost discloses a pole cover device configured as a wrap-around cover which utilizes pairs of string ties to secure the cover to a pole. Although this type of cover may be somewhat inexpensive to manufacture and easy to install or remove (by theft or otherwise), it would likely not provide a secure fitment to a pole since wind will eventually loosen or destroy the members which fasten the cover to the pole. The device would also tend to slide downward on an upright columnar structure, such as a pole with a substantially smooth outer surface. Similar to the devices taught by Dinan and Dinan et al., the Frost device would also require special lifting equipment to install or remove the device if it was desired to mount the device an otherwise unreachable distance above the ground.

U.S. Pat. No. 8,084,115 to Lanzi discloses another pole cover device configured as a wrap-around fabric sheath that uses ties and brackets to secure the sheath to a pole. Lanzi uses a zipper mechanism to attach the sheath to the bracket system, not the pole. Also a ladder or lift mechanism is needed to install the device on the pole an otherwise unreachable distance above the ground. A drawback is that if heavy winds press against the sheath, the sheath is likely to collapse or deform, thus not properly showing the advertising message. Also, a ladder or lift mechanism may be needed to remove the device.

It is also well known within the prior art to utilize flexible adhesive-backed wraps to decorate poles. These wraps are generally difficult to install as they require special lifting equipment (such as that necessary with some of the aforementioned pole cover devices). Wraps can also time consuming to install as air bubbles often tend to form between the wraps's adhesive-backed surface and the pole receiving the wraps, thereby resulting in a wrinkled cover if the air bubbles are not completely removed. Removing air bubbles and wrinkles from the wraps can be time consuming, especially in high wind conditions. It is also doubtful that this type of cover could be successfully applied to a pole in moist atmospheric conditions or where elevated wind conditions are present. Adhesive-backed wraps can also be difficult and time consuming to remove from a pole since the adhesive tends to leave a residue on the pole after being removed. Of course it is usually desirable to also remove the adhesive residue from the pole, which can be time intensive or physically damaging to the pole.

Therefore, it would be desirable if a pole-mountable device were available that was characterized by one or more of the following features: can be securely mounted to a pole (or other generally upright columnar-shaped structure), draws attention to portions of the pole; can be easily and quickly installed on or removed from a pole by utilizing a simple inexpensive tool without relying on expensive lift equipment; its appearance and structural integrity are not detrimentally affected by high wind conditions; does not leave behind an adhesive residue after its removal from a pole; does not harm the pole on which it is mounted or removed; allows different two-dimensional (2D) shapes to be interchangeably placed at elevated locations on a pole without a ladder or lift mechanism to install it; allows luminescent lighted advertising to be placed high on a pole without a ladder or lift mechanism to install it; allows flags and streamers to be placed at elevated locations on a pole without a ladder or lift mechanism to install it; and/or adds circumference to small-diameter poles for increased advertising space without damaging or requiring modifications to the pole.

### BRIEF DESCRIPTION OF THE INVENTION

The present invention provides pole-mountable display systems and methods for mounting such systems to various types of poles and other generally upright columnar-shaped structure, and particularly to display systems that are capable of bearing advertising, information, and/or decorations (ornamentations) to structures to which they are mounted. Preferred embodiments of the invention are also preferably capable of overcoming one or more of the aforementioned shortcomings of the known prior art and/or capable of fulfilling one or more of the aforementioned desirable features of a pole-mountable device.

According to one aspect of the invention, a pole-mountable display system comprises a flexible panel configured to install on a pole to define a display surface. The panel has an interior surface, an exterior surface that defines the display surface, oppositely-disposed first and second edges, and means for securing the first and second edges together. The system further includes a support means for providing rigidity to the flexible panel, and a sleeve adapted to be wrapped around and contact an exterior surface of the pole. The flexible panel is wrapped around and contacts the exterior surface of the sleeve to cause the display surface of the flexible panel to have a larger cross-sectional shape than the pole on which the flexible panel is installed.

Other aspects and advantages of the invention will become apparent from the following detailed description of the invention when considered in conjunction with the drawings.

### BRIEF DESCRIPTION OF THE DRAWINGS

The above mentioned and other features, advantages and objects of this invention, and the manner of attaining them, will become apparent and the invention itself will be better understood by reference to the following description of embodiments of the invention taken in conjunction with the accompanying drawings.

FIG. 1 is a perspective view of a pole-mountable display system installed on a pole according to a nonlimiting embodiment of the invention.

FIG. 2 is a view of a back (interior) side of the display system of FIG. 1 and shows stiffening members that facilitate installation of the display system on a pole.

FIG. 3 is a fragmentary perspective view of a lower portion of the display system of FIG. 1 showing the stiffening members installed in pockets of the display system.

FIG. 4 is a view showing one of the stiffening members of FIGS. 2 and 3 in a disassembled or collapsed state.

FIG. 5 is a perspective view of the display system of FIG. 1 during a process of being installed the pole according to a nonlimiting embodiment of the invention.

FIG. 6 is a perspective view similar to FIG. 5, but showing the use of an elongated hooked tool to assist in the installation of the display system.

FIG. 7 is an isolated view of the elongated hooked tool of FIG. 6.

FIG. 8A represents an isolated perspective view of a foam sleeve adapted for use as a component of a pole-mountable display system in accordance with a nonlimiting embodiment of the invention, FIG. 8B is a perspective view showing the foam sleeve of FIG. 8A installed on a pole and positioned for mounting a pole-mountable display system thereto, and FIG. 8C shows a different and larger foam sleeve installed on the pole of FIG. 8B and a pole-mountable display system mounted to the larger foam sleeve.

FIG. 9A represents components of a pole-mountable display system according to another nonlimiting embodiment of the invention.

FIG. 9B represents the pole-mountable display system of FIG. 9A with the components assembled thereto.

FIG. 9C represents a pole-mountable display system according to another nonlimiting embodiment of the invention.

FIG. 10A represents an illuminated flexible LED light panel with two leads for connecting to plugs of a solar power battery pack represented in FIG. 10B. The light panel and battery pack are both configured for mounting to a pole-mountable display system to generate an illuminated advertising message in accordance with a nonlimiting embodiment of the invention.

FIG. 11A represents a perspective view of a pole-mountable display system equipped with the illuminated flexible LED light panel of FIG. 10A and the solar power battery pack of FIG. 10B.

FIGS. 11B and 11C represent isolated front and top views of a flexible frame shown in FIG. 11A as mounting and protecting the illuminated flexible LED light panel.

FIG. 12A represents a perspective view of a pole-mountable display system equipped with a streamer according to another nonlimiting embodiment of the invention.

FIG. 12B represents an isolated view of the streamer shown in FIG. 12A, as well as examples flags that may be mounted to the display system of FIG. 12A in addition to or instead of the streamer.

### DETAILED DESCRIPTION OF THE INVENTION

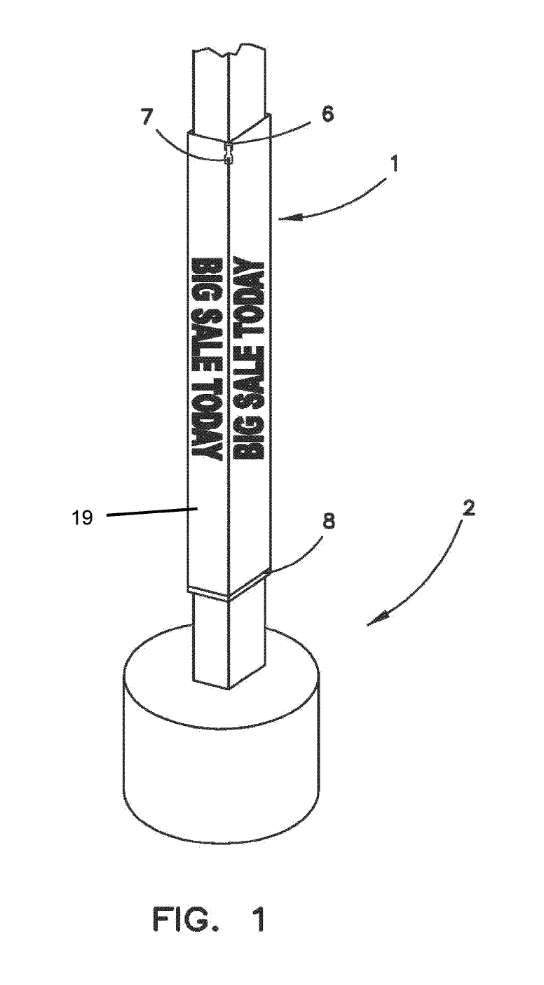

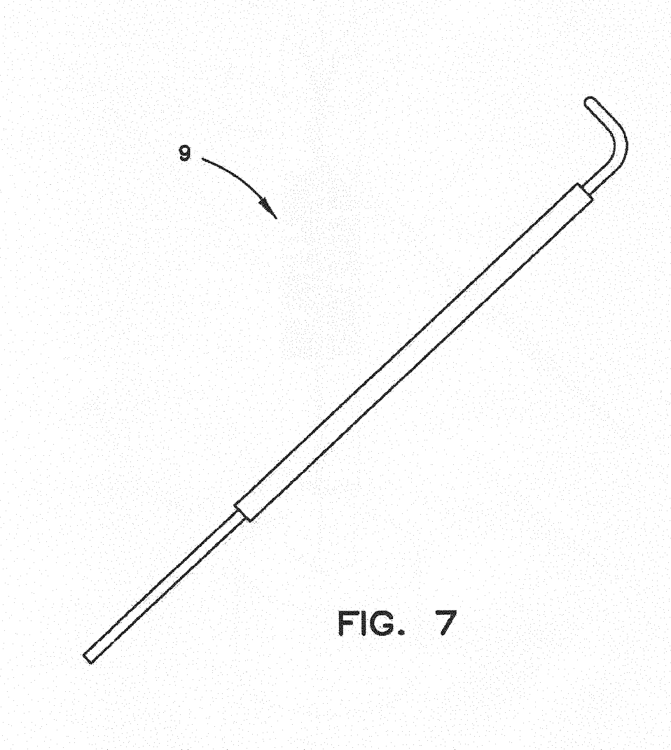

FIGS. 1 through 12B represent nonlimiting embodiments of pole-mountable display systems within the scope of the invention and components thereof. Although the display systems will be described hereinafter in reference to being mounted to poles of types represented in the drawings, it will be appreciated that the teachings of the invention are more generally applicable the installation of display systems on a variety of different types of upright columnar-shaped structures, and particularly such structures that would benefit from having a display system mounted thereto that is capable of bearing advertising, information, and/or decorations. Due to similarities among the embodiments, like reference numerals will be used to indicate the same or similar components and features throughout the figures. The following discussion will focus on particular features, functions, and/or configurations of display systems and their components as shown in the drawings. However, it should be appreciated that not all of the features shown in the figures will necessarily be described, yet will be understood as inherent features by virtue of being shown in the figures.

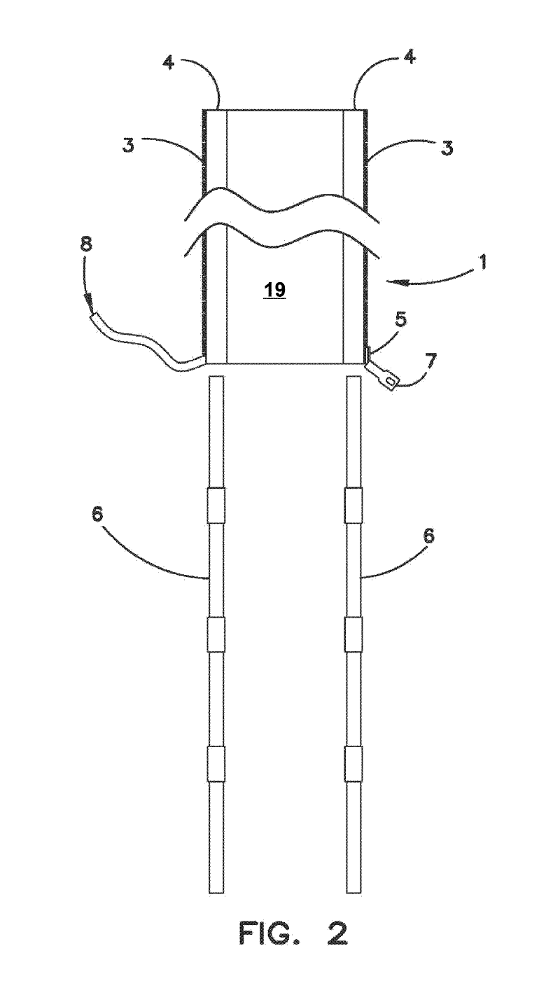

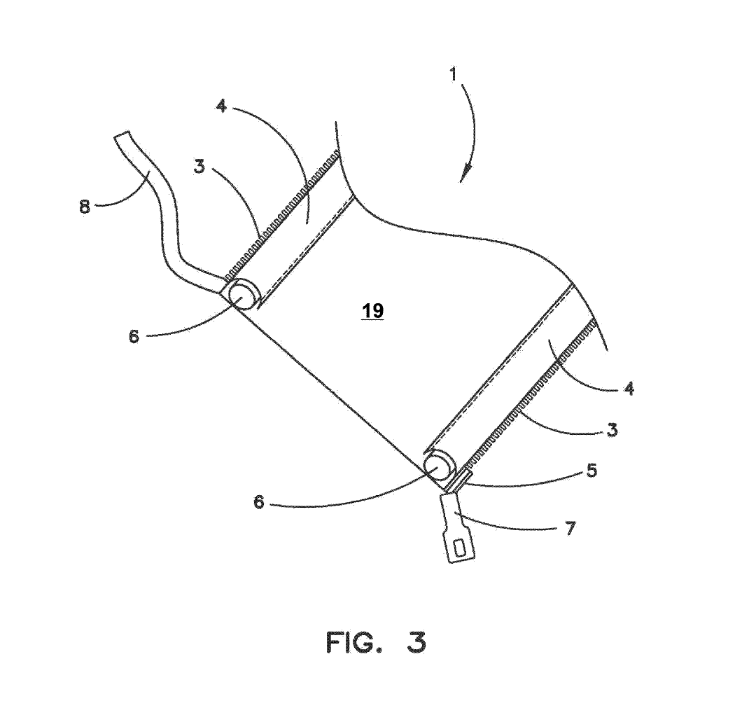

Referring to FIG. 1, a portion of a pole 2 is schematically represented. The pole 2 may be, as nonlimiting examples, a light pole or a pole that supports a traffic control device, an information sign, or some other device or object intended to provide a desired functionality. FIG. 1 further represents a pole-mountable display system 1 fully installed on the pole 2 as a result of two edges of a flexible panel 19 of the display system 1 being secured together so that the display system 1 completely surrounds a perimeter of the pole 2 and an exterior surface of the panel 19 is visible. The exterior surface of the panel 19 is shown in FIG. 1 as carrying an advertisement. As such, the panel 19 is formed of a material that is both flexible and capable of having information printed on or attached to its exterior surface. FIG. 1 represents the edges of the panel 19 secured together with a zipper (indicated by a zipper pull tab 7), though other means for securing the panel edges together are foreseeable and within the scope of the invention. The display system 1 is further represented in FIG. 1 as comprising stiffening members 6 disposed along both edges of the flexible panel 19 and a tension strap 8 at a lower extent of the panel 19. FIG. 2 represents the display system 1 removed from the pole 2, partially disassembled, and placed with the exterior surface of the panel 19 facing downward to reveal zipper halves 3 located on the edges of the panel 19, a zipper slider 5 mounted on one of the zipper halves 3, the zipper pull tab 7 coupled to the slider 5, the stiffening members 6 removed from complementary pockets 4 formed along the edges of the panel 19, and the tension strap 8. FIG. 3 shows a portion of the display system 1 at the lower extent of the panel 19, but with the stiffening members 6 fully installed in their complementary pockets 4. In view of the above-noted aspects and accessories of the display system 1, the flexible material of the panel 19 is preferably capable allowing the zipper halves 3 (or other attachment means) to be attached thereto, and capable of being shaped and fabricated to allow the attachment or installation of the pockets 4, stiffening members 6, and tension strap 8. Various materials are believed to be able to provide these capabilities, including canvas and polymeric materials and fabrics that may include reinforcement, magnetic materials, protective coatings, etc., etc., on the interior and/or exterior surfaces of the panel 19 or incorporated into the material of the panel 19.

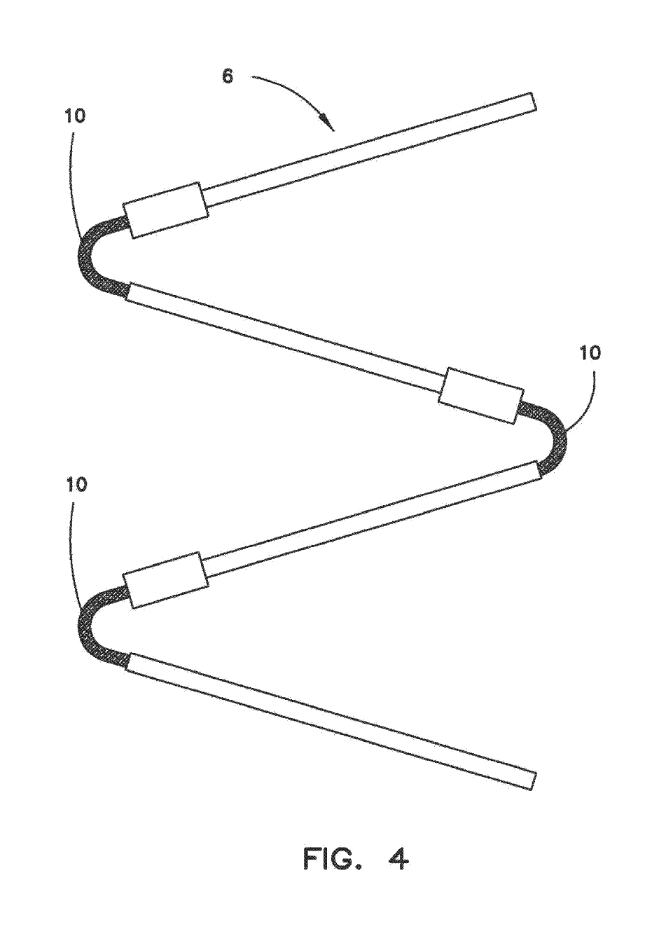

Briefly referring to FIG. 4, one of the stiffening members 6 is shown removed from the display system 1 and unassembled. The stiffening members 6 are represented as pole segments that are semi-detachable from each other in that the segments are joined by an elastic bungee type cord 10. Each stiffening member 6 may be similar in construction to a collapsible tent pole in that it can assembled and disassembled by joining or disjoining its segments. Referring back to FIG. 2, the stiffening members 6 are shown in an assembled state, but are not yet inserted into the display system 1.

Referring again to FIG. 3, the stiffening members 6 can be inserted into the pockets 4 by first configuring the stiffening members 6 as seen in FIG. 2, and then sliding the stiffening members 6 individually into their respective pockets 4. It can be appreciated that although not mandatory, the stiffening members 6 and pockets 4 are sized to cooperatively travel substantially the entire distance as the length of the zipper halves 3. The pockets 4 are sized to accept in a slidable fashion the stiffening members 6.

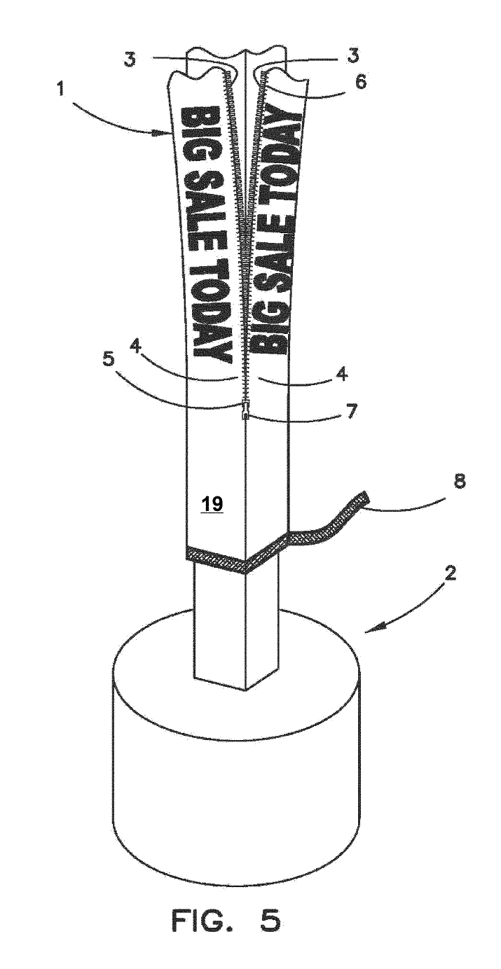

FIG. 5 shows the display system 1 of FIG. 1 partially wrapped around the pole 2 and in the process of being installed or removed from the pole 2. If being installed, the zipper halves 3 are joined by inserting one zipper half 3 that does not contain the zipper slider 5, into the zipper slider 5. During installation the lower portion of the display system 1 may be accessible by a person standing on the ground adjacent the pole 2. The zipper pull tab 7 is grasped and slid in an upward direction thereby starting the engagement of the corresponding teeth of the zipper halves 3. Due to the stiffening members 6 being inserted into the display system 1, the edges of the panel 19 along the zipper halves 3 have enough rigidity to hold the edges in a substantially vertical position in relation to the ground. As a result, the stiffening members 6 prevent the display system 1 from collapsing and the zipper halves 3 from becoming misaligned, thereby facilitating the task of fastening the zipper. 8

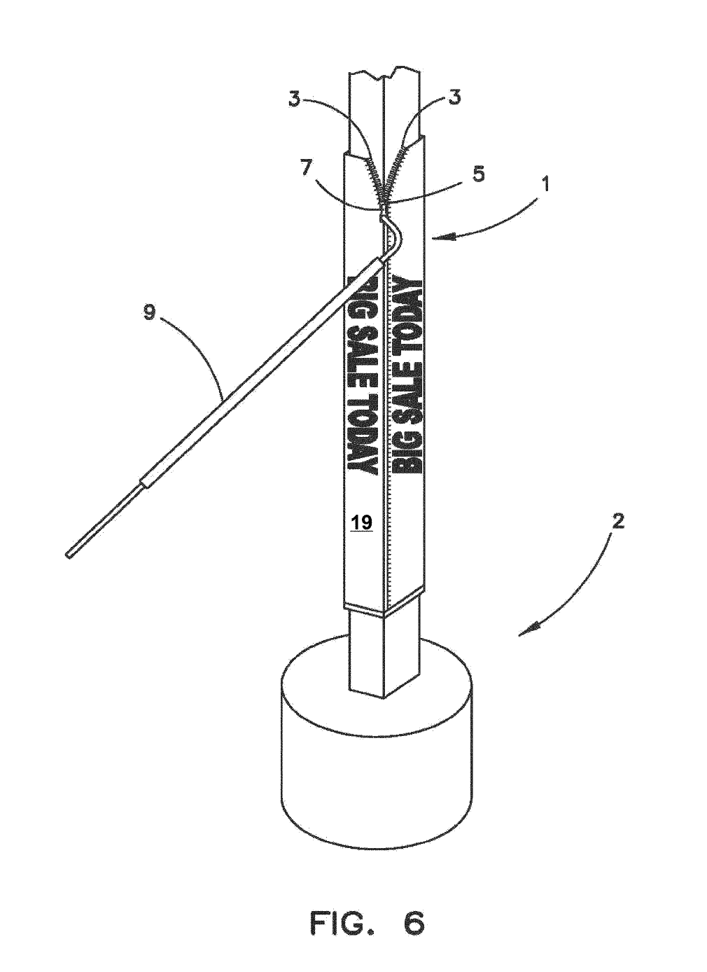

As the zipper slider 5 is slid in an upward direction to fasten the zipper halves 3, there may come a point where the installer is no longer able to slide the zipper slider 5 any higher due to the stature or height limitations of the installer. This occurs primarily when the top of the display system 1 to be installed is positioned at a height that is taller than the installer's reach. Upon such an occurrence, the installer may utilize an elongated hooked tool 9 shown in FIG. 6 to complete the installation. Referring specifically to FIG. 6, the hooked portion of the elongated hooked tool 9 is inserted into an aperture within the zipper pull tab 7. The hooked tool 9 is utilized to slide the zipper slider 5 in an upward fashion along the zipper halve 3 until it reaches the upper ends of the zipper halves 3 at the upper extent of the display system 10.

At this time, the elongated hooked tool 9 can be disengaged from the zipper pull tab 7. Referring again to FIG. 1, upon installation the zipper slider 5 is now located at the top of the display system 1 and may be out of reach from the ground without the elongated hooked tool 9. It can be appreciated that the display system 1 is secure from being removed without authorization since removing it would require the elongated hooked tool 9. It should also be appreciated that the edges of the panel 19 could be secured to each other with a fastening system other than the zipper shown in FIGS. 1-3, 5, and 6.

Upon completing the fastening of the zipper halves 3, the display system 1 is now installed on the pole 2, essentially as represented in FIG. 1. To inhibit the display system 1 from sliding downward on the pole 2 or otherwise moving on the pole 2, the tension strap 8 is preferably wrapped around the pole 2 and secured to itself or to the display system 1. The tension strap 8 can be wrapped in a snug manner so that enough tension is provided between the tension strap 8 and the pole 2 to inhibit movement of the display system 1 in relation to the pole 2. Hook-and-loop fasteners provide a suitable and convenient fastening means for securing the tension strap 8, though it can be appreciated that other suitable means may be employed to secure the tension strap 8, such as but not limited to a snaps, buckle, tie, bungee cord, zipper, magnets, etc.

Due to an intimate surface-to-surface fit between the interior surface of the display system 1 and the exterior of the pole 2, weather conditions such as wind do not have a deteriorating effect on the attachment and structural integrity of the display system 1. Since the display system 1 is installed on the pole 2 without adhesives or other intrusive fasteners, the display system 1 also does not have any detrimental physical effect on the pole 2 to which the display system 1 is mounted. Upon its eventual removal, the display system 1 does not have to be peeled from the pole 2, nor will there be any messy adhesives to clean from the pole 2, which can be a time consuming process that can potentially damage the pole 2. Installation of the display system 1 is relatively quick and easy and may often be performed by one person without any specialized lifting equipment. Also, since the display system 1 is not destroyed during the removal process, the system 1 can be repeatedly reused. Also, the stiffening members 6 can typically be reused in subsequent installations, further promoting the cost efficiency of the display system 1.

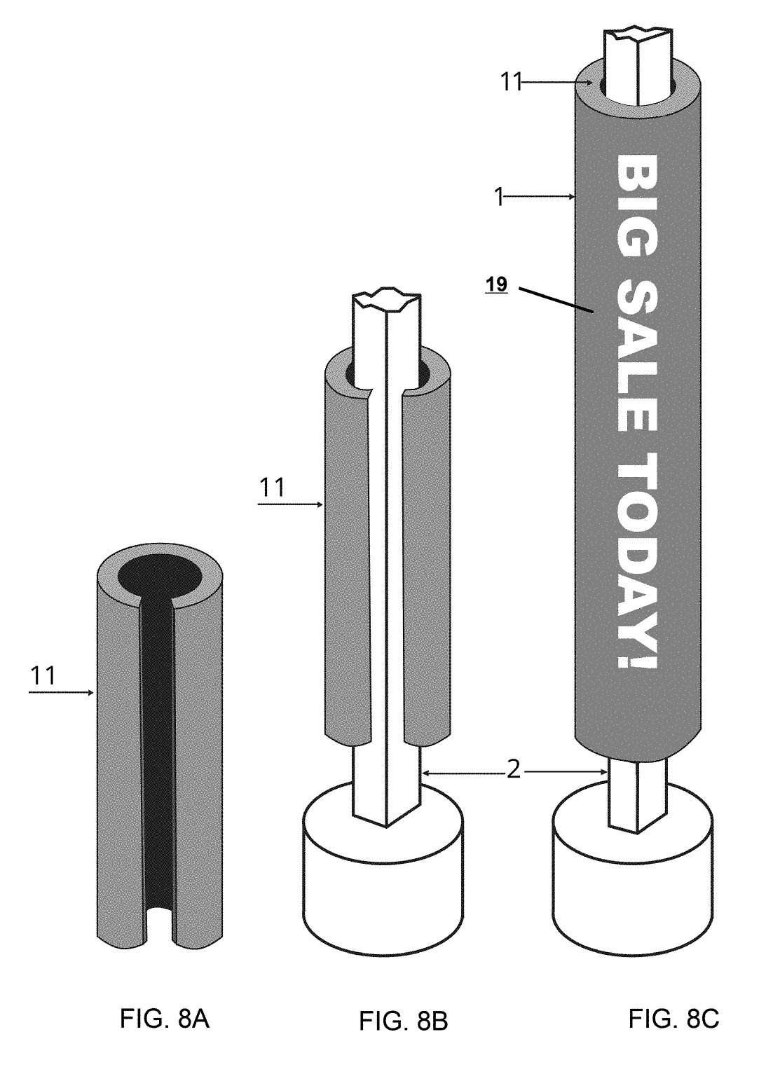

According to certain preferred but nonlimiting aspects of the invention, pole-mountable display systems 1 within the scope of the invention can incorporate additional components that may be integral or discrete components of the system 1. A particular example is the incorporation of one or more sleeves 11, represented in FIGS. 8A, 8B, and 8C. FIG. 8B represents the sleeve 11 of FIG. 8A installed on a pole 2, and FIG. 8C represents a longer sleeve 11 installed on a pole 2. The sleeves 11 effectively increase the diameter or cross-sectional shape of the display system 1, so that poles 2 having small cross-sections can carry relatively large advertisement, information, or decorative displays.

Though a single sleeve 11 is shown installed on each pole in FIGS. 8B and 8C, any number of sleeves 11 of appropriate lengths could be installed end-to-end on a pole 2 to cover a greater portion of the height (length) of the pole 2, as long as the pole 2 is sufficiently long to accommodate the sleeves 11. Furthermore, multiple sleeves 11 could be installed to circumferentially surround one another on a pole 2 to further increase the diameter or cross-sectional shape of the display system 1. The sleeves 11 generally have a tubular shape that defines an interior surface adapted to face and contact the pole 2, an internal cavity formed and surrounded by the sleeve interior surface, and an exterior surface adapted to face and contact the flexible panel 19. Installation of the sleeves 11 on a pole 2 is through a longitudinal slot defined in the sleeve 11 (FIGS. 8A and 8B), through which the pole 2 passes from the exterior surface of the sleeve 11 into the internal cavity of the sleeve 11 as the sleeve 11 is installed on the pole 2 (and, if present, through which a sleeve 11 previously installed on the pole 2 also passes).

Though shown as being circular, various cross-sectional shapes are possible for the shapes of the internal cavity and the interior and exterior surfaces of the sleeves 11, enabling internal cavity of a sleeve 11 to be configured to correspond or conform to a pole 2 of essentially any cross-sectional shape and enabling the exterior surface of a sleeve 11 to define essentially any shape desired for the exterior surface of the flexible panel 19. Preferred materials for the sleeves 11 are lightweight compressible materials, for example, closed-cell foam materials that are elastically compressible, such as a polyethylene compressed foam capable of surviving outdoor environmental conditions for multiple years. Alternatively, the sleeves 11 could be inflatable plastic bags filled with compressed air or a liquid expanding foam system. Another option is to form the sleeves 11 to have pockets that contain inflatable plastic bags filled with compressed air or an expanding foam system. Such alternatives can enable the internal shapes of the sleeves 11 to elastically conform to poles 2 of essentially any cross-sectional shape. In addition, sleeves 11 formed of such elastically compressible materials allow for the flexible panel 19 to be secured to and retained on the sleeve 11 at least in part by creating an interference fit when the exterior of the sleeve 11 is compressed as the edges of the flexible panel are joined together with a connector (for example, the zipper shown in the drawings).

As evident from FIGS. 8A-8B, a pole-mountable display system 1 can be mounted around a single or multiple sleeves 11 mounted to a pole 2. As a result, the sleeves 11 are covered by the flexible panel 19 of the display system 1, and the sleeves 11 are located within the interior of the display system 1 for protection from weather. Importantly, the sleeves 11 and the flexible panels 20 of the display systems 1 can be selectively sized to provide an intimate surface-to-surface contact fit between a pole and the interior surface of the sleeve 11 and between the exterior surface of the sleeve 11 and the interior surface of the display system 1, such that strong winds and other weather conditions have little if any effect on the appearance and structural integrity of the display system 1. Sleeves 11 can be reused in combination with different display systems 1, for example, if the user wants to install a display system 1 having a different advertising, information, or decorative appearance.

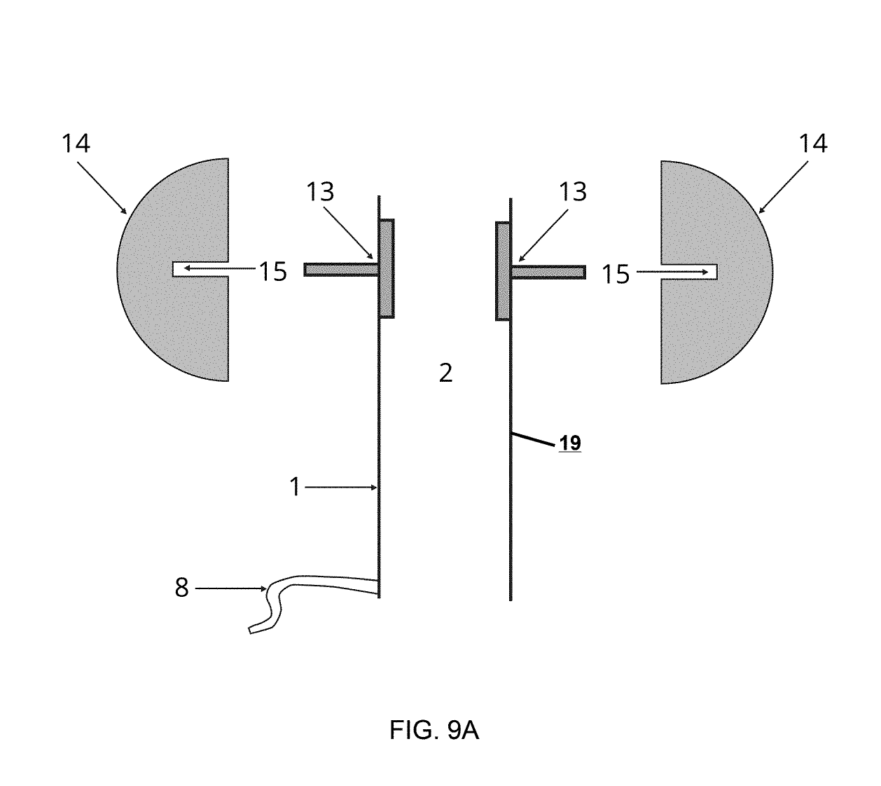

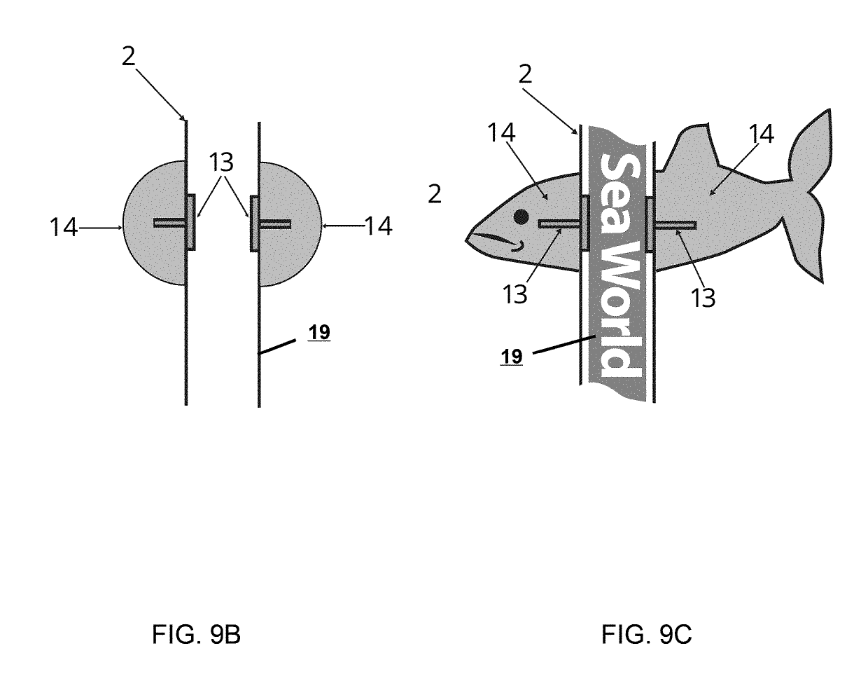

FIGS. 9A, 9B, and 9C represent additional components that may be integral or discrete components incorporated into a display system 1. FIGS. 9A, 9B and 9C represent the capability of incorporating various 2D and 3D shapes that are formed of a lightweight material, for example, foam, to add dimensions and shapes to a display system 1. FIG. 9A depicts a 3D shape 14 as comprising a pair of secure bases 13, each comprising a male rod. The bases 13 are secured to the display system 1 by being mounted to the interior surface of the system 1 so that the male rods extend protrude through the flexible panel 19 and outward from opposite sides of the pole 2. Each shape 14 is represented in FIG. 9A as having a female cavity 15 that is complementary in shape and size to the male rod of one of the bases 13, which in turn can be secured to the cavity 15 with an adhesive or other type of fastener to result in the configuration shown in FIG. 9B. The shape 14 can be tailored to a customer's request and wrapped with adhesive graphics or other decorative elements to contribute a desired appearance to the display system 1. For example, the shapes 14 in FIG. 9C are represented as halves of a fish, with the head on one side of the pole 2 and its tail extending from the opposite side of the pole 2.

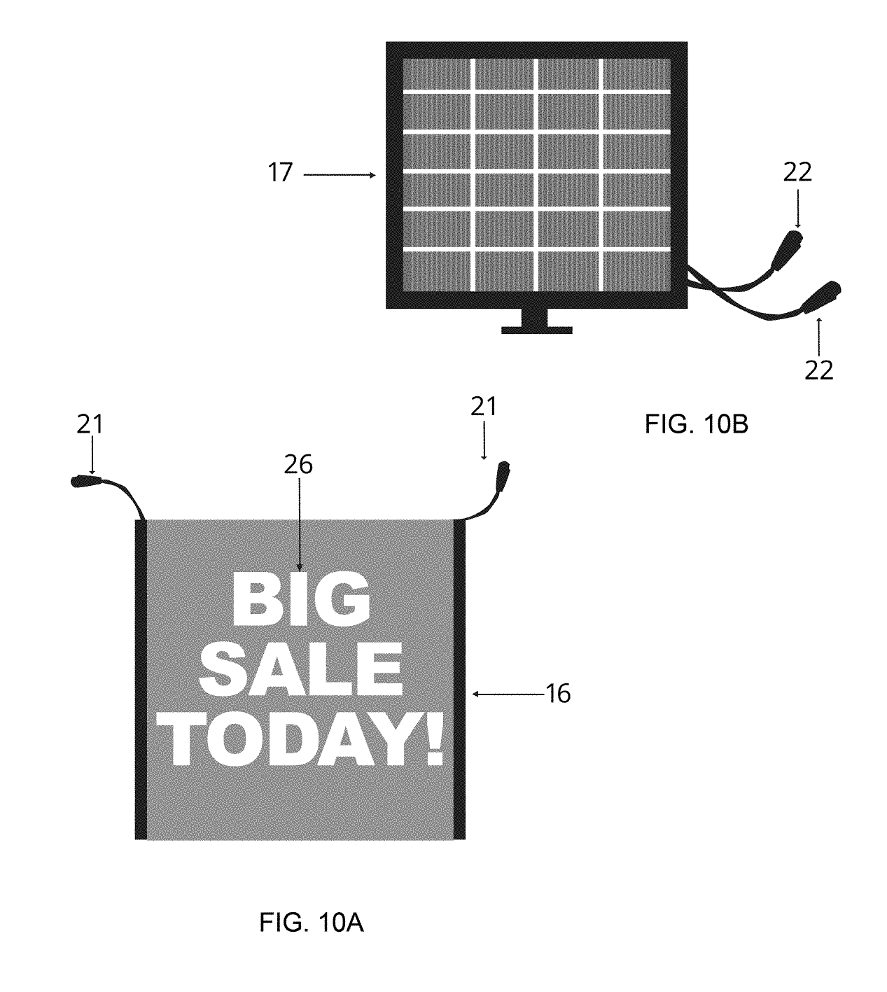

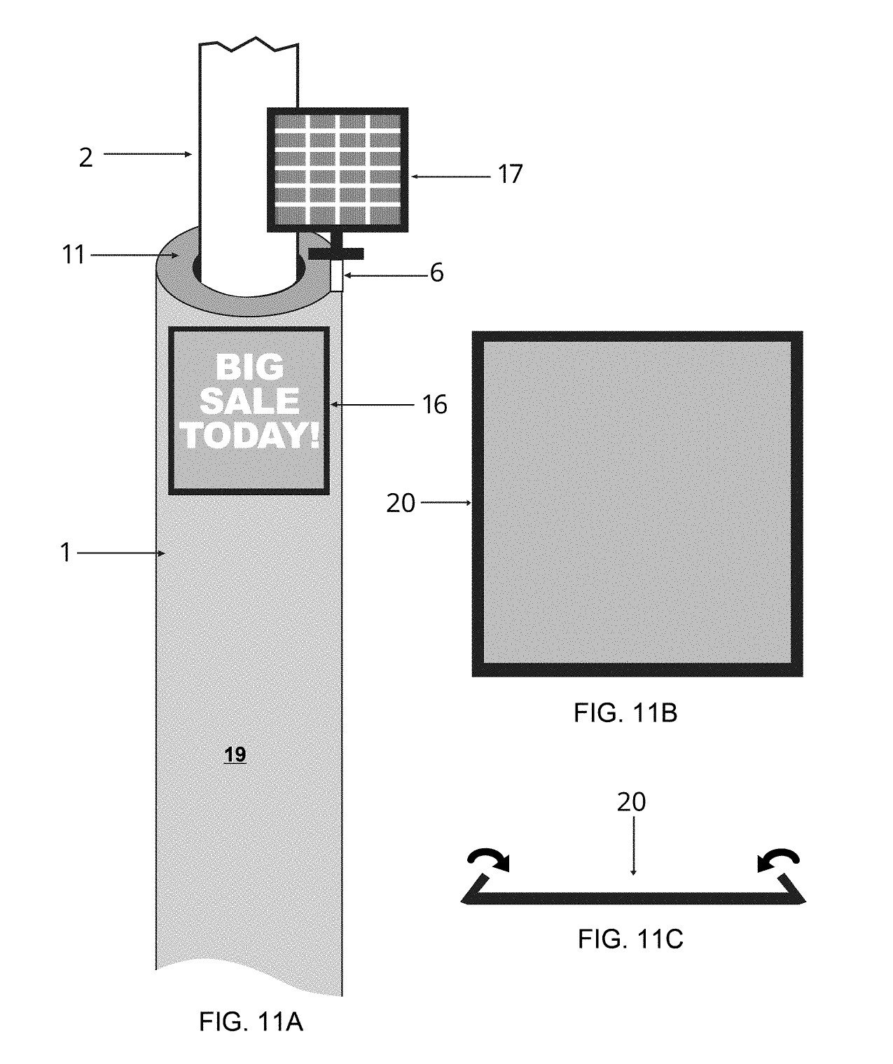

FIGS. 10A and 10B represent, respectively, an illuminated flexible LED light panel 16 and a solar power unit 17 comprising a solar panel and battery pack for supplying power to the light panel 16. The panel 16 and solar power unit 17 are equipped with complementary leads 21 and 22 for electrically connecting the panel 16 and solar power unit 17 together. The light panel 16 and solar power unit 17 are both configured for mounting to a pole-mountable display system to generate an illuminated advertising message, as represented in FIG. 11A. In FIGS. 10A and 11A, the letters 26 of the advertisement may be backlit or front-lit with LED lighting located within or behind the display system 1. FIGS. 11A and 11B represent the inclusion of a flexible frame 20 that surrounds the light panel 16, attaches the panel 16 to the flexible panel 19 of the display system 1, and protects the panel 16 from the weather. The frame 20 may attach to the flexible panel 19 of the display system 1 and to the light panel 16 with any suitable means, for example, hook-and-loop fasteners, snaps, stitches, etc. The flexibility of the light panel 16 and frame 20 allow an advertisement displayed by the panel 16 to be visible over most if not the entire circumference of the display system 1. As an alternative to the solar power unit 17, electricity can be supplied to the light panel 16 from any other available source.

Other uses for an electrically powered display system 1 include the incorporation of surveillance sensors or cameras, for example, to monitor the number and/or activities of people in the vicinity of the display system 1. Surveillance of this type can assist with marketing efforts at indoor or outdoor venues where crowd behavior and traffic patterns are important factors when accessing the layout of a private or community event. The surveillance camera can be embedded in the sleeve 11 at or near the top of the display system 1 so as to be somewhat undetectable.

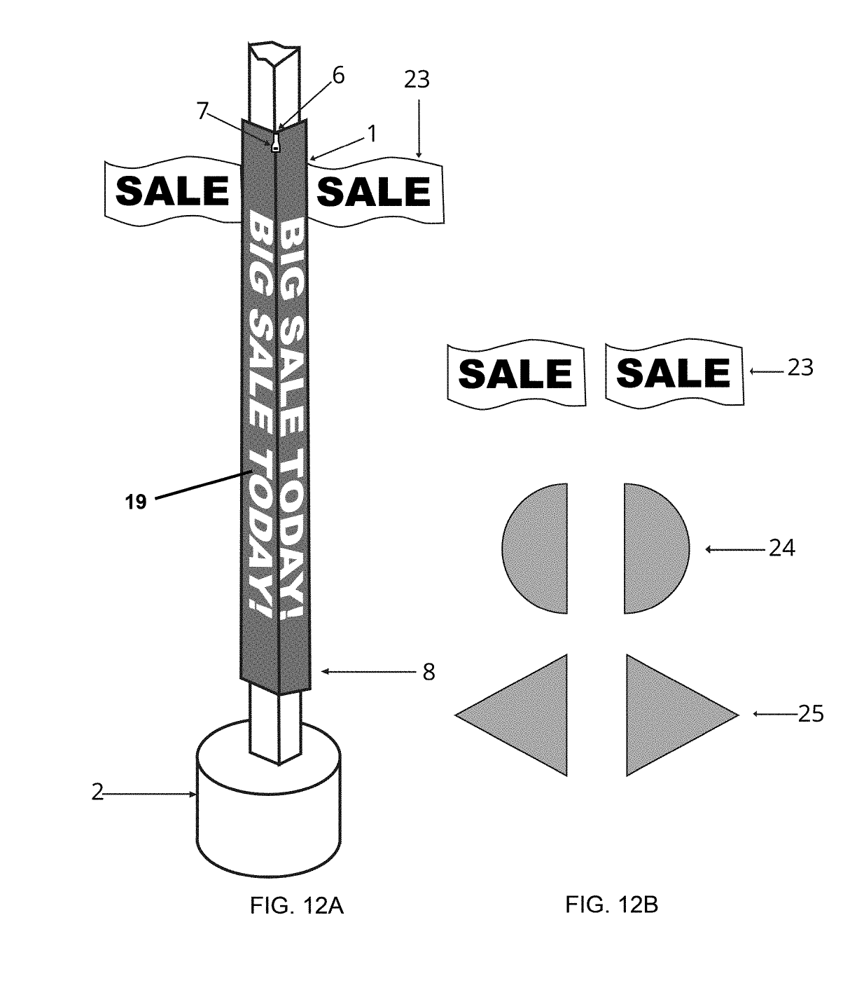

Finally, FIGS. 12A and 12B represent the ability to incorporate other decorative features into display systems 1 of this invention. FIG. 12A represents a pair of banners or streamers 23 that extend from opposite sides of the display system 1 and carry additional information, in this case, advertising information. FIG. 12B shows the streamers 23 of FIG. 12A in isolation, along with two different styles of flags 24 and 25 that can be similarly mounted to the display system 1 of FIG. 12A. Similar to the streamers 23, the flags 24 and 25 can have advertising messages on them, may be produced in bright colors, or have readily recognizable outlines, for example, the American flag or a company logo. The shapes and materials of the streamers 23 and flags 24 and 25 can be chosen to achieve a variety of desired appearances, including the movements of the streamers 23 and flags 24 and 25 in response to wind to add an additional means of attracting attention from a distance on windy days. The streamers 23 and flags 24 and 25 are preferably located at or near the top of the display system 1 for higher visibility. The streamers 23 and flags 24 and 25 represented in FIGS. 12A and 12 B may be attached to the display system 1 with any suitable means, for example, hook-and-loop fasteners, snaps, stitches, etc., prior to installing the system 1 on a pole 2.

Display systems 1 of the types described above and shown in the drawings are capable of being employed in a wide variety of settings, a particular but nonlimiting example of which is in parking lots to provide advertising or as directional signage. The display systems 1 can be mounted on light poles within a parking lot to provide readily identifiable information from long distances, for example, to identify specific parking areas for patrons, customers, employees, and personnel. The display systems 1 can be easily moved from one pole to another in the event that parking areas or sizes need to be altered. Shapes 14, streamers 23, and flags 24 and 25 mounted to the display systems 1 can provide large and highly visible graphics to assist customers when recalling where they parked their vehicle.

From an installers point of view, a significant advantage of display systems 1 described above and shown in the drawings is that the systems 1 are collapsible for shipping. Certain embodiments of the display system 1 may expand twenty feet or more, yet can be collapsed to a size that permits the display system 1 to be shipped in a small box with all of its components. As such the systems 1 are capable of reducing the cost of shipping and require minimal storage space.

While the invention has been described in terms of specific or particular embodiments, it should be apparent that alternatives could be adopted by one skilled in the art. For example, the display system 1 and its components could differ in appearance and construction from the embodiments described herein and shown in the drawings, functions of certain components of the system could be performed by components of different construction but capable of a similar (though not necessarily equivalent) function, and appropriate materials could be substituted for those noted. In addition, the invention encompasses additional or alternative embodiments in which one or more features or aspects of the disclosed embodiments could be eliminated and different disclosed embodiments may be combined. Accordingly, it should be understood that the invention is not necessarily limited to any embodiment described herein or illustrated in the drawings. It should also be understood that the phraseology and terminology employed above are for the purpose of describing the illustrated embodiments, and do not necessarily serve as limitations to the scope of the invention. Therefore, the scope of the invention is to be limited only by the following claims.

1. A pole-mountable display system comprising:
a flexible panel configured to install on a pole to define a display surface, the flexible panel having an interior surface, an exterior surface that defines the display surface, oppositely disposed first and second edges, and connector means for securing the first and second edges together;
support means for providing rigidity to the flexible panel; and
at least a sleeve adapted to be wrapped around and contact an exterior surface of the pole, the flexible panel being wrapped around and contacting an exterior surface of the sleeve to cause the display surface of the flexible panel to have a larger cross-sectional shape than the pole on which the flexible panel is installed.

2. The pole-mountable display system according to claim 1, wherein the sleeve has a tubular shape that defines an interior surface adapted to face and contact the exterior surface of the pole, an internal cavity formed and surrounded by the interior surface of the sleeve, and the exterior surface adapted to face and contact the interior surface of the flexible panel.

3. The pole-mountable display system according to claim 2, wherein the sleeve has a longitudinal slot that enables the pole to pass from the exterior surface of the sleeve into the internal cavity of the sleeve.

4. The pole-mountable display system according to claim 1, wherein the sleeve is formed of an elastically compressible material that enables the sleeve to conform to the exterior surface of the pole.

5. The pole-mountable display system according to claim 1, wherein the pole-mountable display system comprises a plurality of the sleeve.

6. The pole-mountable display system according to claim 1, further comprising means for mounting 2D and 3D shapes to the flexible panel so that the shapes extend away from the display surface of the flexible panel.

7. The pole-mountable display system according to claim 1, further comprising at least a first base secured to the flexible panel and a male rod projecting from the flexible panel.

8. The pole-mountable display system according to claim 7, further comprising a 2D or 3D shape mounted to the flexible panel with the male rod so as to extend from the display surface of the flexible panel.

9. The pole-mountable display system according to claim 1, further comprising lighting mounted to the interior and/or exterior surfaces of the flexible panel or protruding through the flexible panel to illuminate the display surface.

10. The pole-mountable display system according to claim 9, wherein the lighting is solar powered.

11. The pole-mountable display system according to claim 1, wherein the support means comprises a first stiffening member disposed along the first edge of the flexible panel and a second stiffening member disposed along the second edge of the flexible panel.

12. The pole-mountable display system according to claim 11, wherein the first and second stiffening members are removably disposed in pockets located along the first and second edges of the flexible panel.

13. The pole-mountable display system according to claim 1, further comprising a flag or streamer mounted to the flexible panel and protruding from opposite sides of the flexible panel.

14. A method of mounting the pole-mountable display system of claim 1 to the pole, the method comprising:
installing the sleeve around the pole so as to contact the exterior surface of the pole;
wrapping the flexible panel around the sleeve to contact an exterior surface of the sleeve and cause the display surface of the flexible panel to have a larger cross-sectional shape than the pole; and
joining the first and second edges of the flexible panel with a connector.

15. The method according to claim 14, further comprising inserting at least one stiffening member into the flexible panel before joining the first and second edges thereof.

16. The method according to claim 14, wherein the flexible panel is secured to and retained on the sleeve at least in part by creating an interference fit by compressing the sleeve as the first and second edges of the flexible panel are joined together with the connector means.

17. A method of mounting a pole-mountable display system on a pole, the method comprising:
installing a sleeve around the pole so that an interior surface of the sleeve contacts an exterior surface of the pole;
wrapping a flexible panel around the sleeve to contact an exterior surface of the sleeve and cause an exterior display surface of the flexible panel to have a larger cross-sectional shape than the pole; and
joining first and second edges of the flexible panel with a connector means.

18. The method according to claim 17, further comprising inserting at least one stiffening member into the flexible panel before joining the first and second edges thereof.

19. The method according to claim 17, wherein the flexible panel is secured to and retained on the sleeve at least in part by creating an interference fit by compressing the sleeve as the first and second edges of the flexible panel are joined together with the connector means.

20. The method according to claim 17, wherein the pole is chosen from the group consisting of light poles, poles that support a traffic control device, and information sign poles.
